(19) United States
(12) Patent Application Publication
(10) Pub. No.: US 2011/0142250 A1
(43) Pub. Date: Jun. 16, 2011

(54) GRADIENT COIL NOISE MASKING FOR MPI DEVICE

(75) Inventors: Ingo Schmale, Hamburg (DE); Thomas Koehler, Norderstedt (DE)

(73) Assignee: KONINKLIJKE PHILIPS ELECTRONICS N.V., Eindhoven (NL)

(21) Appl. No.: 13/058,230

(22) PCT Filed: Aug. 11, 2009
(86) PCT No.: PCT/IB2009/053517

§ 371 Date: Feb. 9, 2011

(30) Foreign Application Priority Data
Aug. 14, 2008 (EP) 08162372.0

(51) Int. Cl. H04R 3/02

(52) U.S. Cl. 381/73.1

(57) ABSTRACT

When subjecting a patient to an MRI scan, noise generated by gradient coils in an MRI device is beautified by playing a complementary musical piece that matches the gradient coil noise in one or both of tempo and musical key. Complementary musical pieces (e.g., songs, tunes, melodies, etc.) are pre-generated for specific gradient coil sequences. Upon selection of one or more sequences to be executed during an MR scan, complementary musical pieces for the selected sequence(s) are identified and played back to a patient in the bore of the MRI device during the scan to alleviate patient stress. Tempo and/or musical key of the complementary musical pieces is adjustable (a priori or in real time) to synchronize the complementary musical piece(s) to a specific gradient sequence both rhythmically and harmonically.

### FIELD OF THE INVENTION

The present innovation finds particular application in subject imaging systems, particularly involving magnetic resonance imaging (MRI). However, it will be appreciated that the described technique may also find application in other imaging systems, other medical scenarios, or other medical techniques.

### BACKGROUND OF THE INVENTION

In MRI devices, a patient lying in the bore of the main magnet is subjected to considerable noise levels that are created in the bore due to gradient switching, helium pump operation, ventilation equipment, etc. In order to protect the ears of the patient, circumaural headphones are sometimes provided. Additionally, an operator of the MRI device may communicate with the patient via such headphones. However, the headphones do not provide sufficient attenuation of the ambient noise, and considerable noise reaches the patient's ears through tissue and bone conduction. Even with the best circumaural headphones, patients are subject to considerable noise levels, largely originating from the gradient coil system in the MRI device.

Moreover, patients experience considerable discomfort (e.g., physical, psychological, emotional, etc.) when undergoing an MRI scan. For instance, the patient may be experiencing physical pain due to an illness, psychological or emotional pain or worry related to the illness, claustrophobia due to the cramped space within the bore of the MRI device, etc. The loud repetitive noise of the gradient coils can exacerbate these discomforts, increasing patient stress.

The present application provides new and improved systems and methods for beautifying and complementing noise generated by medical imaging devices such as MRI systems, which have the advantages of reducing patient stress and improving patient comfort, and which overcome the above-referenced problems and others.

### SUMMARY OF THE INVENTION

In accordance with one aspect, a noise beautification system for a magnetic resonance imaging device includes one or more memories that stores a music library having a plurality of complementary songs, a sequence library having a plurality of MRI acquisition gradient sequences, and a lookup table (LUT) in which gradient sequences are cross-referenced with complementary songs according to at least one matching criterion. The system further includes a processor that receives selected gradient sequence information, performs a table lookup to identify one or more complementary songs matching the selected gradient sequence; and plays the one or more identified complementary songs during the selected gradient sequence to complement the noise generated by a gradient coil in the MRI device.

According to another aspect, a method of beautifying gradient coil noise during a magnetic resonance imaging acquisition scan includes detecting a gradient coil sound parameter for a selected gradient sequence, identifying one or more stored complementary musical pieces that match the selected gradient sequence, as a function of the gradient coil sound parameter, and outputting the one or more identified complementary music pieces during execution of the selected gradient sequence to beautify the gradient coil noise.

One advantage is that patient comfort is improved.

Another advantage resides in reducing patient stress during an MRI scan.

Still further advantages of the subject innovation will be appreciated by those of ordinary skill in the art upon reading and understand the following detailed description.

### BRIEF DESCRIPTION OF THE DRAWINGS

The innovation may take form in various components and arrangements of components, and in various steps and arrangements of steps. The drawings are only for purposes of illustrating various aspects and are not to be construed as limiting the invention.

FIG. 1 illustrates a system architecture that includes a noise beautification system (NBS) coupled to an MRI device.

FIG. 2 illustrates the NBS, which aligns and/or overlays harmonically and rhythmically complementary tones or sounds to the gradient noise to improve patient comfort and reduce stress during an MRI scan.

FIG. 3 illustrates several exemplary measures of the gradient noise represented as a monotonal rhythmic piece of music.

FIG. 4 illustrates an exemplary musical piece that can be played to complement the gradient noise, in accordance with various embodiments.

Corresponding reference numerals when used in the various figures represent corresponding elements in the figures.

### DETAILED DESCRIPTION OF EMBODIMENTS

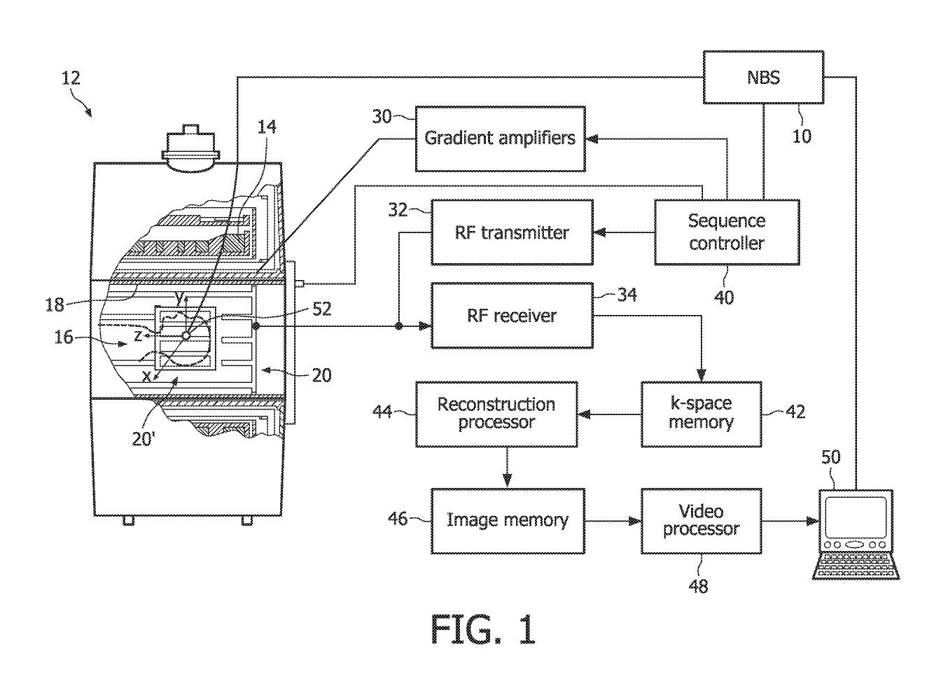

The systems and methods described herein facilitate beautifying noise generated by components of an MRI device during a scan of a patient to improve patient comfort and reduce patient stress. With reference to FIG. 1, a system architecture is illustrated that includes a noise beautification system (NBS) 10 coupled to an MRI device 12. The following discussion provides a brief overview of the MRI device 12, and factors thereof that contribute to patient discomfort, which can be alleviated through the introduction of harmonically and rhythmically aligned sounds provided by the NBS 10.

The MRI device 12 includes several components that create noise when the MRI device is operational, which can contribute to patient discomfort and/or stress. For instance, the MR device includes a cylindrical main magnet assembly 14. The main magnet assembly 14 may be a superconducting cryoshielded solenoid, defining a bore 16 into which a subject is placed for imaging. The main magnet assembly 14 produces a substantially constant main magnetic field (also called B₀ magnetic field) oriented along a longitudinal axis of the bore 16. Although a cylindrical main magnet assembly 14 is illustrated, it is to be understood that other magnet arrangements, such as vertical field, open magnets, non-superconducting magnets, and other configurations can be used.

A gradient coil 18 produces magnetic field gradients in the bore 16 for spatially encoding magnetic resonance signals, for producing magnetization-spoiling field gradients, or the like. In one embodiment, the magnetic field gradient coil 18 includes coil segments configured to produce magnetic field gradients in three orthogonal directions, typically longitudinal or z, transverse or x, and vertical or y directions. When the gradient coil switches between gradients, a loud noise is produced. Because gradient switching occurs frequently and rapidly, this noise can become annoying to a patient in the bore of the device for an extended period of time.

Several components of the MRI device can additionally contribute to patient discomfort by creating conditions that may trigger claustrophobia in the patient. For instance, a whole body radio frequency coil assembly 20 (e.g., a birdcage coil assembly) generates radio frequency pulses for exciting magnetic resonance in dipoles of the subject. The radio frequency coil assembly 20 also serves to detect magnetic resonance signals emanating from the imaging region. It is desirable from an imaging standpoint to have the coils and magnets of the MRI device close to the patient to improve image quality. However, the whole body coil assembly 20 reduces available space in an already small imaging bore.

Additionally, an optional local coil 20′ is illustrated within the bore 16 for more sensitive, localized spatial encoding, excitation, and reception of magnetic resonance signals. However, such local coils further reduce available space in the bore 16. Various types of coil arrays can be employed in the MRI device, such as a simple surface RF coil with one output, a quadrature coil assembly with two outputs, a phased array with several outputs, a SENSE coil array with dozens of outputs, combined RF and gradient coils with both outputs and inputs, and the like.

Gradient pulse amplifiers 30 deliver controlled electrical currents to the magnetic field gradient coils 18 to produce selected magnetic field gradients. The gradient amplifiers also deliver electrical pulses to the gradient coils of local coil arrays that are equipped with gradient coils. A radio frequency transmitter 32, analog or digital, applies radio frequency pulses or pulse packets to the radio frequency coil assembly 20 to generate selected magnetic resonance excitations. A radio frequency receiver 34 is coupled to the local coil 20′ to receive and demodulate the induced magnetic resonance signals. Optionally, the whole body coil 20 is connected to the receiver in a wired or wireless interconnection.

To acquire magnetic resonance imaging data of a subject, the subject is placed inside the magnet bore 16, with the imaged region at or near an isocenter of the main magnetic field. Scan times may be of the order of tens of minutes (e.g., 30 minutes, etc.), during which the patient must remain as still as possible while the gradient noise drones on and on. A sequence controller 40 communicates with the gradient amplifiers 30 and the radio frequency transmitter 32 to produce selected transient or steady-state magnetic resonance sequences, to spatially encode such magnetic resonances, to selectively spoil magnetic resonances, or otherwise generate selected magnetic resonance signals characteristic of the subject. The generated magnetic resonance signals are detected by the local coil 20′, communicated to the radio frequency receiver 34, and stored in a k-space memory 42. The imaging data is reconstructed by a reconstruction processor 44 to produce an image representation that is stored in an image memory 46. In one embodiment, the reconstruction processor 44 performs an inverse Fourier transform reconstruction.

The resultant image representation is processed by a video processor 48 and displayed on a user interface 50 equipped with a human-readable display. The interface 50 is a personal computer or workstation in one embodiment. The user interface 50 also allows a radiologist or other operator to communicate with the magnetic resonance sequence controller 40 to select magnetic resonance imaging sequences, modify imaging sequences, execute imaging sequences, and so forth. Often, several gradient sequences are employed in each MRI data acquisition. The acquisition sequences determine the noise characteristics generated by the gradient coils during the scan.

In order to soothe the patient during an MRI scan, the NBS 10 alters the quality of the gradient noise by providing harmonically and rhythmically aligned sounds to the underlying gradient strokes and other noise, thereby transforming the otherwise annoying gradient noise into relaxing music for the patient. The NBS 10 is coupled to sequence controller 40 and the user interface 50 and receives input therefrom related to, for instance, a particular MRI scan sequence to be employed when scanning the patient. The NBS is further coupled to the MRI device 12, and provides music complementing the gradient noise to the patient therein. In one embodiment, the complementary music is provided through headphones 52 worn by the patient, which may be coupled directly to the NBS or to the MRI device, while the gradient noise (e.g., notes, beats, continuous sound) is heard in the background. In another embodiment, the complementary music is provided through speakers mounted in the vicinity of the MRI device or to the MRI device itself for the benefit of technicians or others in the MRI room.

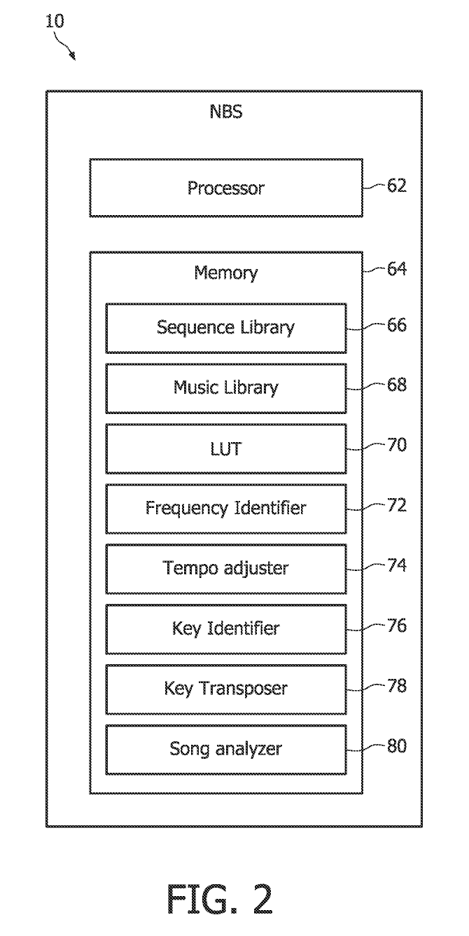

FIG. 2 illustrates the NBS 10, which aligns and/or overlays harmonically and rhythmically complementary tones or sounds to the gradient noise to improve patient comfort and reduce stress during an MRI scan. The NBS includes a processor 62 that executes computer-executable instructions stored in a memory 64 for carrying out the various functions described herein. The memory 64 comprises a sequence library 66 in which are stored a plurality of gradient sequences associated with a plurality of respective MRI scan types. Alternately, the sequence library is in a memory of the sequence controller 40 (FIG. 1). Each sequence in the library includes information related to noise frequency, pitch, tone, etc. The memory also comprises a music library 68 that includes a plurality of musical pieces (e.g., songs, tunes, melodies, etc.) that are employed by the processor to complement and beautify the gradient noise. In one embodiment, complementary musical pieces are specifically generated for each of the gradient sequences stored in the sequence library, and match a criterion or parameter of the gradient coil sounds that occur during the sequences, such as tempo and/or musical key. Upon receipt of a selected gradient sequence, the processor accesses a lookup table (LUT) 70 to identify one or more pieces of music that match a predefined tempo of the gradient noise. In one embodiment the selected gradient sequence is determined automatically from information associated with selected MRI scan parameters. In another embodiment, the selected sequence information is input to the user interface 50 (FIG. 1) and received therefrom by the NBS.

If only one musical piece is matched to the selected sequence, that musical piece is automatically selected for playback during the scan. If more than one song is matched, the songs may be randomly played in any order, played according to a predetermined ordering, presented to a user on the user interface for ordering and/or selection, etc.

In one embodiment, the gradient noise is treated as a percussion instrument that provides a tempo or rhythm for the complementary music. In this case, the tempo or rhythm is determined as a function of gradient switching frequency, and musical pieces are matched accordingly. Additionally, the memory 64 comprises a frequency identifier 72 that is executed by the processor 62 to analyze the gradient switching frequency to determine a rhythm or tempo, and a tempo adjuster 74 that is executed by the processor to adjust the tempo of one or musical pieces in the music library to match the tempo of the selected gradient sequence. In one embodiment, the frequency identifier samples the gradient noise to determine the tempo at which the complementary musical piece should be played. Tempo identification and adjustment can be performed prior to playback or on the fly during the MRI scan. If performed in real time, the NBS includes a microphone (not shown) that detects the gradient noise for sampling and/or analysis. In playback mode, a signal (e.g., a timing signal, a trigger signal, a synchronization signal, or the like) is passed from the sequence controller 40 to the NBS 10. In real-time on-the-fly mode, synchronization and/or alignment is realized by analyzing the signal from the microphone.

In another embodiment, the pitch or fundamental frequency of the gradient noise is identified, and the NBS includes the pitch information when selecting, adjusting, and/or playing a complementary music track. For instance, the memory 64 includes a key identifier 76 that is executed by the processor 62 to detect the pitch of the gradient noise and identify a musical key corresponding thereto. The memory further includes a key transposer 78 that is executed by the processor to adjust the key of one or more musical pieces in the music library to match the key of the sound produced by the selected gradient sequence. For instance, if the fundamental frequency of the gradient noise is determined to correspond to a “G” on the octave scale, then songs in the key of G can be selected and/or songs in other keys can be transposed into the key of G and played back to complement and beautify the gradient noise. Key identification and adjustment can be performed prior to playback or on-the-fly during the MRI scan. It will be appreciated that the frequency identifier 72, the tempo adjuster 74, the key identifier 76, and/or the key adjuster 78 comprise computer-executable algorithms or instructions that are stored to the memory 64 and executed by the processor 62 to carry out the various actions and functions described herein.

In another embodiment, the music library includes songs categorized by genre, and patients or users are permitted or prompted to select one or more genres from which complementary songs are selected. For instance, songs may be classified into one or more genres including but not limited to classical music, children's songs, country music, rock music, rap music, pop music, and so on. In one example, a user can indicate a preference (e.g., via the user interface 50 of FIG. 1) for children's songs when the patient is a pediatric patient. In this scenario, a child undergoing an MRI scan can be particularly uncomfortable due to the strange noises and atmosphere in the MRI device, and familiar children's songs can alleviate the child's fears.

In another embodiment, the memory 64 stores, and the processor 62 executes, a song analyzer 80 that analyzes a downloaded song or audio file in a predefined format (e.g., MP3, .wma, etc.) and generates a version thereof in a format compatible for playback to complement the gradient noise. Conversion can be performed prior to the MRI scan. According to one feature, patients can request one or more songs in advance of an appointment and provide a digital version thereof that can be converted by the song analyzer 80. In a related embodiment, the key identifier and key transposer convert the reformatted song version into a key compatible with the pitch of sound produced by the selected gradient, and the frequency identifier and tempo adjuster adjust the tempo of the reformatted song version to match the tempo of the gradient sound.

In yet another embodiment, the NBS 10 is employed in conjunction with a functional MRI (fMRI) device, and additional information related to the patient's brain activity while listening to the beautified gradient sound is collected for analysis. Additionally or alternatively, brain activity information acquired during an fMRI scan can be used to analyze how patients react to the reduced gradient noise during playback of the complementary musical piece, relative to un-beautified gradient noise. This embodiment facilitates analyzing brain activity responsive to musical stimulation.

It will be appreciated that the described NBS 10 is not limited to being employed with an MRI device, but rather may additionally be employed with multimodal imaging devices, including but not limited to positron emission tomography (PET)/MRI devices, single photon emission computed tomography (SPECT)/MRI devices, computed tomography (CT)/MRI devices, etc.

It will further be appreciated that the NBS 10 of FIGS. 1 and 2 can be integral to an MRI device or can be a stand-alone system that is retrofitted to existing MRI devices. In the latter example, noise beautification is facilitated by analysis of the tempo and/or tone of the gradient noise, adjustment of the tempo and/or key of a selected complementary musical piece, and so on using the above-described components of the NBS.

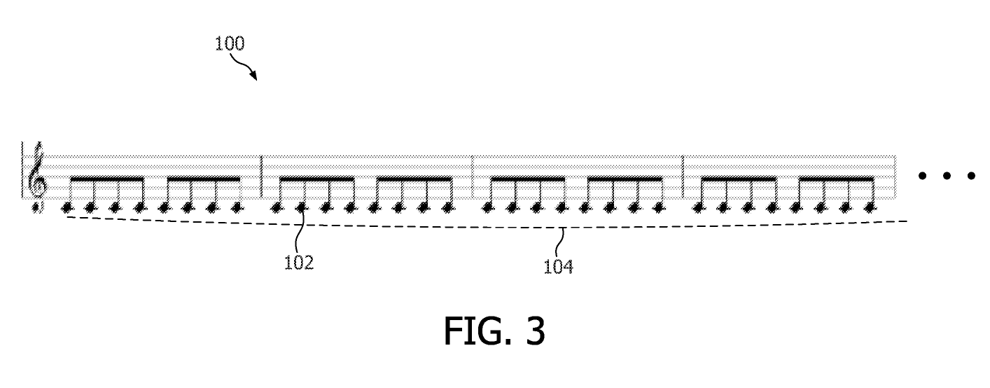

FIG. 3 illustrates several exemplary measures of the gradient noise represented as a monotonal rhythmic piece of music 100. “Exemplary” is used herein to mean “an example of” or the like, and is not to be construed as meaning “preferred” or “optimal” or the like. Each beat 102 of the gradient noise is represented by an eighth note, although the gradient noise is not constrained to this representation, and the “beats” thereof may be of any duration or frequency. Additionally, in this example the gradient beats are shown in 4/4 time, although they are not limited to such an arrangement. Rather the beats or notes may be arranged in 2/4 time, 3/4 time, 3/3 time, etc., in order to be compatible with a selected complementary musical piece or song. For instance, the beats may be set to 3/4 time if the selected musical piece is a waltz, and so forth. It will be appreciated that the gradient beats need not have a tonal value. For example, in one embodiment the repetitive gradient beats are equated to a percussion instrument providing a rhythm or tempo for a complementary musical piece played during an MRI scan.

In another embodiment, the gradient beats 102 have a tonal value and are treated as a musical note that is complemented by a musical piece played during the MRI scan, in addition to providing a tempo for the musical piece. In the illustrated example, the gradient beats have a tonal value of “C” on the treble clef.

In yet another embodiment, the gradient sound is continuous, as indicated by the tie 104 (shown as a dashed line) across the eighth notes in FIG. 3, which could also be represented as whole notes, half notes, quarter notes, or any combination of different note durations, etc. In this embodiment, all notes are “tied,” such that the gradient sound is represented as single continuous and sustained note.

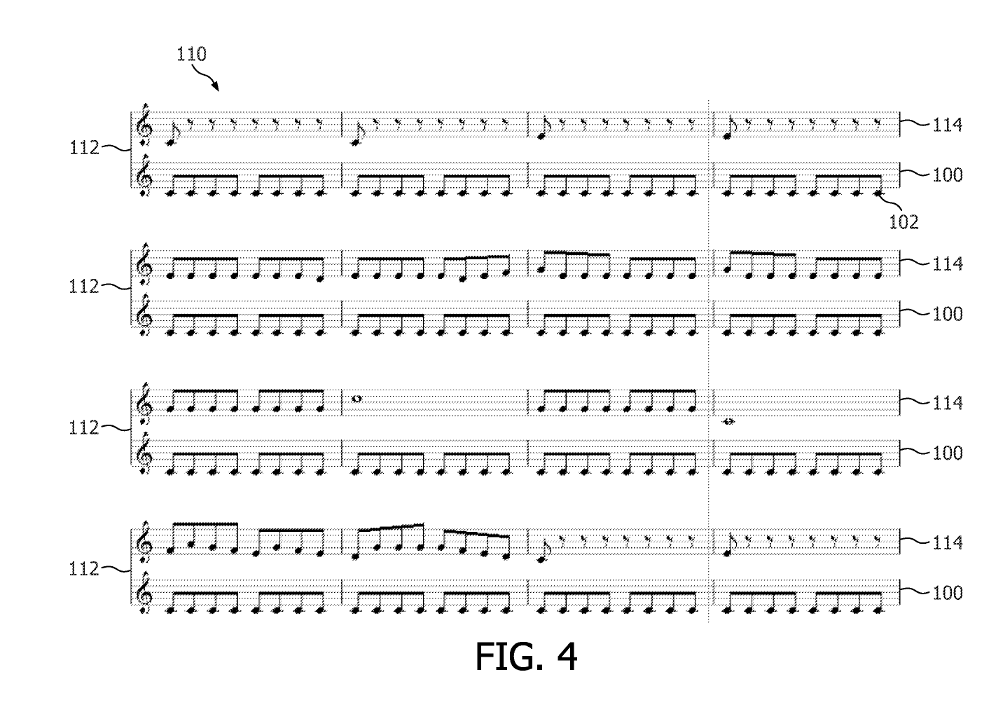

FIG. 4 illustrates an exemplary musical piece 110 that can be played to complement the gradient noise, in accordance with various embodiments. The piece comprises several measures 112, each of which comprises the monotonal rhythmic piece of music or rhythm 100 and a complementary tune 114 that comprises notes complementary to the gradient noise or rhythm. If the gradient notes 102 have a tonal value, the tune 114 is in the same key as the gradient notes 102. If not, then the gradient notes 102 are toneless and act as percussion, and the tune 114 may be in any key. In either example, if the gradient noise is punctuated, it serves as a basis for a tempo to which the tune 114 is played back during the MRI scan. If the gradient noise is continuous, then the tune 114 may be played at any tempo. In one embodiment the tune is played at a tempo that approximates a relaxed human heart rate, to encourage the patient to relax. For example, if an MRI acquisition sequence has 240 “beats” per minute, then every fourth note in the complementary musical piece can be emphasized to bring the tempo down to 60 beats per minute. It will be appreciated that the tune 114 is illustrative in nature and that any suitable tune or musical composition can be employed in conjunction with the various systems and methods described herein.

In another embodiment, certain notes in the complementary piece are emphasized to create rhythm in the musical piece, such as every eighth note, every sixteenth note, and so on. For instance, depending on the tempo and/or time (e.g., 2/4, 3/4, 4/4, 3/3, 6/8, etc.) of the complementary musical piece being played back, notes may be emphasized in a pattern designed to approximate human respiratory patterns (e.g., 12 breaths per minute, etc.) in order to relax the patient.

In yet another embodiment, the gradient sequence may be adjusted to match the tempo of a selected complementary musical piece.

The innovation has been described with reference to several embodiments. Modifications and alterations may occur to others upon reading and understanding the preceding detailed description. It is intended that the innovation be construed as including all such modifications and alterations insofar as they come within the scope of the appended claims or the equivalents thereof. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The disclosed embodiments can be implemented by means of hardware comprising several distinct elements, or by means of a combination of hardware and software. In the system claims enumerating several means, several of these means can be embodied by one and the same item of computer readable software or hardware. The mere fact that certain measures are recited in mutually different dependent claims does not indicate that a combination of these measures cannot be used to advantage.

1. A noise beautification system (10) for a magnetic resonance imaging (MRI) device (12), comprising:
one or more memories (64) that stores a music library (68) having a plurality of complementary musical pieces, a sequence library (66) having a plurality of MRI acquisition gradient sequences, and a lookup table (LUT) (70) in which gradient sequences are cross-referenced with the stored complementary musical pieces according to at least one matching criterion; and
a processor (62) that receives selected gradient sequence information, performs a table lookup to identify one or more complementary musical pieces matching the selected gradient sequence; and plays the one or more identified complementary musical pieces during the selected gradient sequence to complement noise generated by a gradient coil (18) in the MRI device (12).

2. The system according to claim 1, wherein the at least one matching criterion is tempo.

3. The system according to claim 1, wherein the at least one matching criterion is musical key.

4. The system according to claim 1, including:
a frequency identifier (72) that samples gradient noise generated by the gradient coil (18) and determines a tempo thereof.

5. The system according to claim 4, including:
a tempo adjuster (74) that adjusts a tempo of the one or more identified complementary musical pieces to match the tempo of the gradient coil noise.

6. The system of claim 5, wherein the processor (62) emphasizes predetermined notes in the one or more identified complementary musical pieces to cause the tempo of the musical piece to be perceived as a tempo in the range of approximately 40-60 beats per minute to be consistent with a relaxed human heart rate.

7. The system of claim 5, wherein the processor (62) emphasizes predetermined notes in the one or more identified complementary musical pieces to cause the tempo of the musical piece to be perceived as a tempo in the range of approximately 10-15 beats per minute to be consistent with a relaxed human respiratory rate.

8. The system according to claim 1, including:
a key identifier (76) that samples gradient noise generated by the gradient coil (18) and identifies a fundamental frequency or pitch thereof.

9. The system according to claim 5, further including:
a key transposer (78) that adjusts a musical key of the one or more identified complementary musical pieces to match the pitch of the gradient coil noise.

10. The system according to claim 1, wherein the processor (62) outputs the one or more identified complementary musical pieces to at least one of speakers or headphones during the selected gradient sequence.

11. A method of beautifying gradient coil noise during a magnetic resonance imaging (MRI) acquisition scan, including:
detecting a gradient coil sound parameter for a selected gradient sequence;
identifying one or more stored complementary musical pieces that match the selected gradient sequence, as a function of the gradient coil sound parameter; and
outputting the one or more identified complementary music pieces during execution of the selected gradient sequence to beautify the gradient coil noise.

12. The method according to claim 11, wherein the gradient coil sound parameter is a frequency of occurrence of the gradient coil noise that occurs when a current in the gradient coil changes, and wherein the one or more identified complementary musical pieces have a tempo that matches the frequency of occurrence of the gradient coil noise.

13. The method according to claim 11, wherein the gradient coil sound parameter is a pitch of a gradient coil noise that occurs when a current in the gradient coil changes, and wherein the one or more identified complementary musical pieces have a musical key that matches the pitch of the gradient coil noise.

14. The method according to claim 11, further including:
adjusting at least one of a tempo and a musical key of the one or more identified complementary musical pieces to match at least one of a frequency of occurrence of the noise and a pitch or tone of the magnetic resonance imaging noise, respectively.

15. The method according to claim 11, further including:
emphasizing predefined notes in the complementary musical piece, the emphasized notes being spaced apart in time, to reduce the perceived tempo of the beautified gradient coil noise.
